(19) United States
(12) Patent Application Publication
(10) Pub. No.: US 2008/0098826 A1
(43) Pub. Date: May 1, 2008

(54) Apparatus For Measuring The Force Of Brake Actuators

(75) Inventors: Holger Luthje, Halstenbek (DE); Saskia Biehl, Saarbrucken (DE); Andreas Schirling, Pfungstadt (DE); Bernward Bayer, Rodermark (DE)

Correspondence Address: BARNES & THORNBURG LLP, 11 SOUTH MERIDIAN, INDIANAPOLIS, IN, 46204, US

(73) Assignee: CONTINENTAL TEVES AG & Co.oHG, Frankfurt am Main (DE)

(21) Appl. No.: 11/795,273

(22) PCT Filed: Jan. 19, 2006
(86) PCT No.: PCT/EP06/00450

§ 371 Date: Dec. 6, 2007

(30) Foreign Application Priority Data
Jan. 19, 2005 (DE) 10 2005 002 523.4

(51) Int. Cl. G01L 5/28

(52) U.S. Cl. 73/862.581; 73/121

(57) ABSTRACT

The invention relates to a force measuring assembly for processing pressure signals in electronic, especially electromechanical, brake systems, particularly for motor vehicles comprising at least one force sensor subassembly and at least one signal processing device per wheel brake. At least one force sensor subassembly encompasses a brake actuator (2, 3) that is in non-positive connection with at least one pressure component (1) which is provided at least in part with an amorphous piezoresistive diamond-like carbon layer (4) forming a force sensor.

The invention relates to a force-measuring arrangement for processing force signals in electronic brake systems, in particular vehicle brake systems comprising a force sensor subassembly and a signal processing device, the force sensor subassembly comprising a brake actuator and at least one pressure component, an amorphous diamond-like carbon layer being applied on the pressure component as force sensor.

In recent times, new electromechanical brake systems (EMB) have become known, which systems serve as car external force brake unit with a full brake-by-wire function without hydraulic or pneumatic elements. With these systems, the wishes of the driver are detected by a pedal sensor system and, in the central electronics, corresponding control commands are transferred to the wheel brakes. The “dry” wheel modules (brake actuators without hydraulic fluid, with “local intelligence” in the form of wheel electronics) convert these control commands into the corresponding brake moment of each wheel. The assignment of the control forces/brake moments to the different wheels (front/rear, right/left) is effected by evaluation of information from the internal sensor system (brake application force, travel), the surroundings sensor system (driver assistance) and also the travel dynamics sensor system (vehicle) and hence is adapted to the current travel state, environmental conditions and various other influences on an optimal and individual wheel basis. The EMB system relies on a reliable power system which has a redundant construction. The control-technical information and signals are transmitted via a specific bus system. Here also there is a dual circuit system for safety reasons. An electrical locking brake (parking brake) is integrated at the rear axle brake actuators.

A modification of this full EMB system is represented by the hybrid brake in which the front axle is still hydraulically braked in a conventional manner but the rear axle already contains the EMB actuator system including an electrical parking brake. For this purpose, only a single onboard electrical power system is required since the hydraulics represent the legally specified second brake circuit.

In every case, the mechanical measurement of the tension force of the brake linings on the brake disc is necessary within the brake systems, in particular within the mechatronic brake actuator system, in order to enable continuous controls.

Sensor systems known to date are not suitable for this task. An example is described in DE 103 08 798 A1 where a pressure measuring arrangement for redundant processing of pressure signals in electronic brake systems and the use thereof is disclosed. A sensor subassembly comprising a plurality of electrical pressure measuring elements is thereby described, said elements being disposed together on a membrane.

A further solution which is known from prior art is described in DE 103 147 98 A1. This concerns an actuation unit for an electromechanically actuatable disc brake.

The known embodiments of brake force-measuring devices in vehicle brakes are hence either indirectly measuring systems, for example the hydraulic pressure being measured with the help of for example membrane-like sensors, or sensors are applied according to the wire strain principle which provide deformation (lengthening or shortening) of an underlayer, generally a specially shaped sensor pick-up. The known solutions concern discrete wire strain gauges which are glued on to the basic body and consequently have very complex calibration requirements. A further disadvantage is the lack of system rigidity (deformation is required in the case of wire strain gauges) and the lack of the ability to be integrated in miniaturised and low-mass brake units.

Starting herefrom, it is therefore the object of the present invention to indicate a force-measuring arrangement which, even under extreme requirements with respect to mechanical and thermal loading and also from cost aspects, is suitable for use in automotive vehicles.

The object is achieved by the characterising features of patent claim 1. The sub-claims reveal advantageous developments.

According to the invention, a force-measuring arrangement is hence proposed, which has at least one force sensor subassembly, the force sensor subassembly comprising at least one brake actuator and a pressure component which is in frictional connection therewith, at least one amorphous carbon layer which acts as force sensor being applied on the pressure component.

The advantage of the invention can be seen in the fact the amorphous carbon layer has the following properties:
force/pressure sensor with extremely high rigidity
temperature sensor
excellent tribological property, corrosion-stable

The measurement of the current force is effected with the help of a resistance measurement which is effected through the layer and which enables also static measurements over an extended period of time. For highly dynamic measurements, the advantage of this force sensor resides in the fact it is very low-mass.

The amorphous carbon layer, because of its hardness (15-40 GPa) and a measuring principle which acts in the layer normal, enables a low-mass and completely rigid measuring arrangement. As a result, it is possible to produce a force sensor in for example rotational-symmetrical disc form for this application field, which is integrated in brake systems, without the rigidity and dynamics of the system being affected disadvantageously. Furthermore, the layer is extremely wear-resistant and corrosion-stable so that it has excellent suitability for the demanding application in the case of vehicle brakes. The force measurement in the case of this thin film sensor is effected by a change in the electrical resistance and in fact preferably in the layer normal. In this respect, the diamond-like sensor layer can be integrated directly into the force flow of the brake actuator.

The amorphous carbon layer which forms the force sensor is preferably a diamond-like carbon layer which has become known with the title a:CH, i-CH, Me:CH, DLC and Me:DLC. According to the invention, the amorphous carbon layer can have graphite structures with sp² hybridisation in combination with diamond-like structures with sp³ hybridisation. As is known from prior art, the layers can be provided with metallic and/or non-metallic doping elements. A layer of this type is described in DE 199 45 164 A1. Hence reference is made expressly to the entire disclosure content of this document.

The production of the amorphous carbon layers which are used according to the invention can be effected by means of conventional PVD and/or plasma CVD processes or by a combination of both processes. For this purpose commercially available sputtering plants or plasma CVD plants can be used. Reference is made by way of example for this purpose to EP-B-008736.

The amorphous carbon layers according to the invention preferably have a hardness of approx. 20 GPa and are applied in the thickness range of 1 to 10 μm.

Preferably a pressure plate, cylinder, disc or ring is used as pressure component in the force sensor subassembly according to the invention. Basically all the component parts of a brake actuator which are situated in the force flow are suitable according to the present invention.

In addition to the force measurement, the temperature of the sensor and hence of the brake actuator can be measured also in order to increase the reliability of the brake system. The temperature measurement serves, on the one hand, for compensation of the temperature characteristics of the force sensor but also for monitoring and optimising the actuator control. The temperature measurement with the help of the amorphous carbon layer can be effected such that the resistance of the layer is measured at one point which is thermally balanced but not situated in the force flow.

In order to couple the force and temperature measurements, line-connected solutions can be used. For this purpose, for example the thin film electrodes are provided with a strip conductor and a bonding spot and these are then connected in the known manner to a wire by bonding or soldering or gluing. The contact surfaces can be protected subsequently by a sealing compound.

A further embodiment of the invention resides in an integrated evaluation circuit in that for example an ASIC or other microelectronic components are applied directly on the force sensor, i.e. on the amorphous carbon layer or on a suitable component of the brake system which also carries the amorphous sensory coating. The connection of the force sensor or in the case of local subdivision of the sensor is effected with the help of a thin film circuit or, in the known manner, with wire bonding/soldering, gluing.

The invention relates furthermore to the use of an amorphous carbon layer as force sensor for vehicle brake systems, in particular electromechanical brake systems.

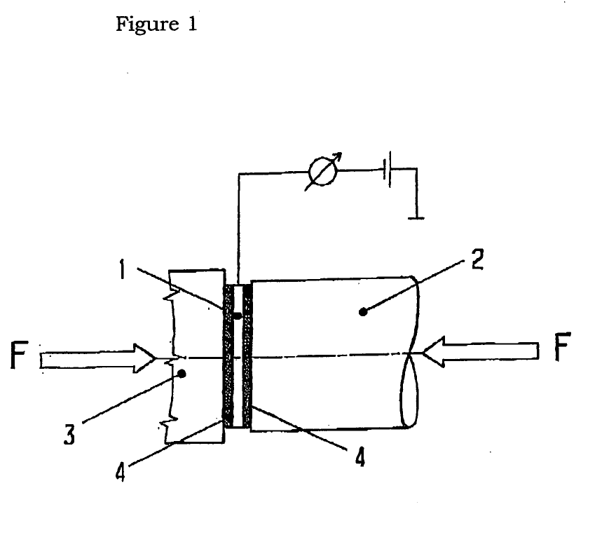

The invention is explained subsequently in more detail with reference to FIGS. 1 to 6.

FIG. 1 shows an embodiment in which the pressure component is configured in the form of a metal disc which acts as pressure body within the brake actuator.

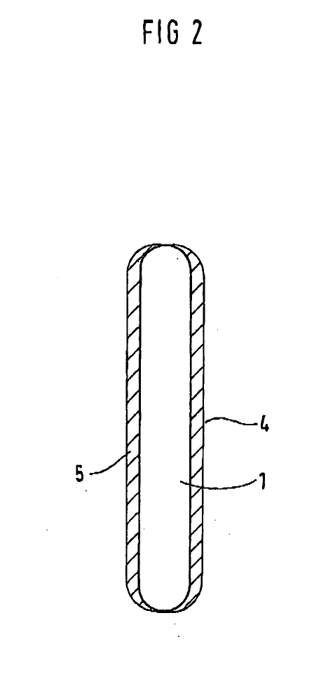

FIG. 2 shows an embodiment with a coating on one side with the amorphous carbon layer and an electric insulating coating on the rear side.

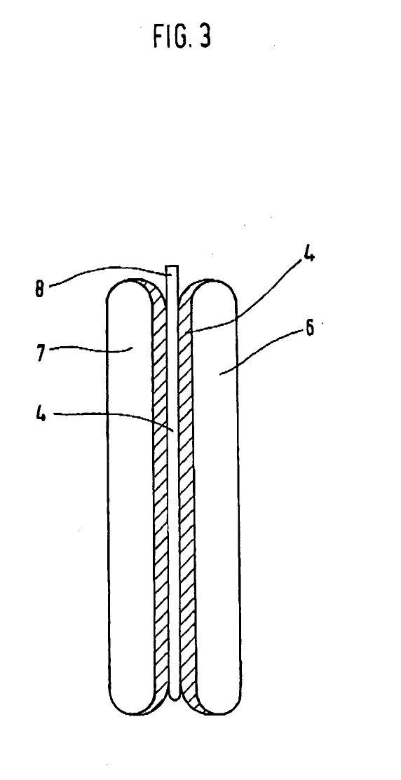

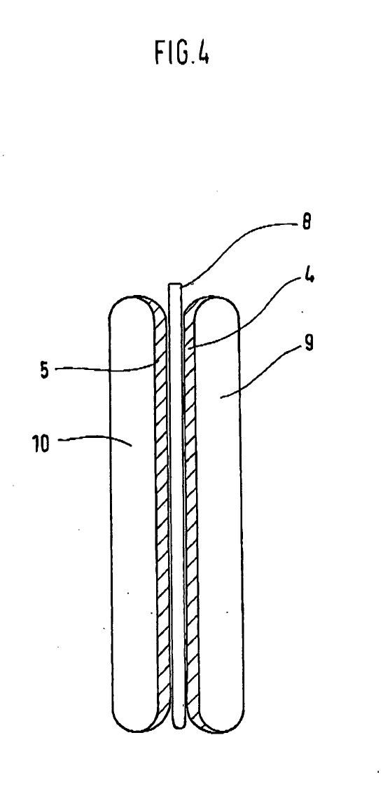

FIGS. 3 and 4 show an embodiment in which the pressure component is constructed from two discs with a central electrode.

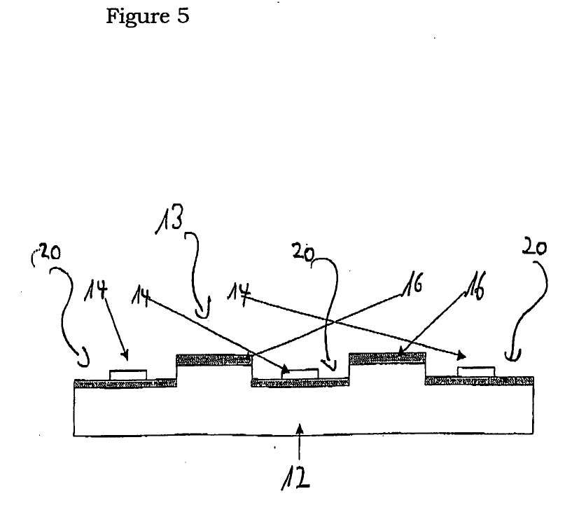

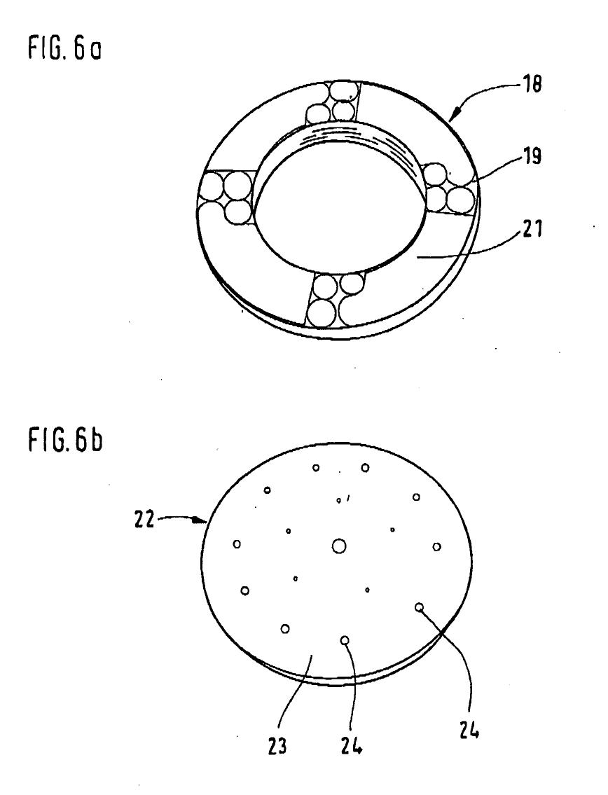

FIGS. 5, 6a and 6b show embodiments with simultaneous application of local electrodes for temperature measurement.

FIG. 1 now shows an embodiment in which the pressure component is configured as a metal disc 1, the metal disc 1 serving at the same time as pressure body between two actuator components 2 and 3 which are located in the tension force flow. The metal disc 1 which serves as pressure body is provided on both sides with an amorphous piezoresistive carbon layer 4 with a layer thickness of 4 μm. In the embodiment according to FIG. 1, the change in resistance of the layer is measured in the case of action of the brake force on the pressure plate 1 (in this case via the measuring line with the pressure plate 1, measurement of the layer resistance of the front and rear side, which are connected in parallel, being effected relative to earth).

FIG. 2 now shows an embodiment in which there are present a coating on one side of the pressure plate 1 with the force-sensing amorphous carbon layer 4 and application of an electrically insulating coating 5 on the rear side. Known thick and thin film processes can be applied for this purpose, e.g. sputtering of Al₂O, AlN, SiO₂ or SiN. Advantageously, plasma CVD layers made of SiCON can also be applied or organic layers and as far as insulating paints. The measurement is then effected likewise relative to earth, only the change in resistance of the amorphous carbon 4 layer being evaluated.

In addition to the above-described embodiments of the force-measuring arrangement according to the invention, the invention also extends to embodiments comprising two pressure components. FIGS. 3 and 4 show the embodiments in this respect.

In the embodiment according to FIG. 3, two pressure plates 6, 7 are provided which are provided with an amorphous piezoresistive sensor layer 4 on the sides which face each other. Between the piezoresistive sensor layers 4, a sheet metal-like electrode 8 (e.g. comprising stainless steel with a coating made of Me-DLC, Ni, Cr or the like) is disposed between the pressure plates 6 and 7. This construction can also have recesses for producing non-force-loaded temperature sensors and electrical contacts and also openings for an electronic circuit. It is also a component of the invention that the construction is closed hermetically with suitable means. This can be effected for example with a sealing compound or glue, known mechanical covering processes or welding processes.

FIG. 4 now shows a comparable embodiment to that according to FIG. 3 but this embodiment comprises two pressure plates 9 and 10, the sides of the pressure plates which face each other being provided in the case of one pressure plate, namely in the case of the pressure plate with the reference number 9, with the amorphous piezoresistive carbon layer 4 and the other pressure plate 10 with an insulating layer 5. In this respect, reference is made to the embodiments of FIG. 2, wherein the theoretical construction and mode of operation of a pressure component of this type have already been described.

A further advantageous embodiment of the invention is the possibility of subdividing the amorphous piezoresistive carbon layer mechanically or geometrically such that local force-pressure measurements are also possible. This is shown schematically in FIGS. 5 and 6. FIG. 5 shows in section an embodiment of this type, the pressure component 12 having surface profilings 13 which serve to receive the temperature sensor and/or the electronic circuit 14. In addition, for example the support surface can be subdivided by milling and/or structured thin film electrodes are applied on the amorphous carbon layer. In a further embodiment, a separate counter-body which has structured surfaces or electrodes can also be used. In FIG. 5, the amorphous carbon layer is designated with 16. The raised regions 16 then serve for force measurement. In amorphous carbon-coated sections 20 which are not located in the force flow, the simultaneous measurement of the component temperature can in addition be achieved in this embodiment.

The embodiments proposed according to FIGS. 6a and 6b also permit the construction of local force-measuring cells and force-sensing networks.

In the embodiment according to FIG. 6a, a pressure ring 18 is provided which is provided with a piezoresistive sensor layer 19 and local electrode structures 21 on the surface. The contacting point was coated with copper on one electrode structure 21 and a measuring wire was soldered on.

The embodiment according to FIG. 6b comprises a pressure plate 22 with a piezoresistive amorphous sensor layer 23 and circular electrode structures 24 on the surface in order to implement force measurement with local resolution.

1. A force-measuring arrangement for processing pressure signals in brake systems having at least one force sensor subassembly and at least one signal processing mechanism per brake wherein the at least one force sensor subassembly comprises a brake actuator which is in frictional connection to at least one pressure component, the at least one pressure component being provided at least partially with an amorphous piezoresistive diamond-like carbon layer which forms a force sensor.

2. Apparatus according to claim 1 wherein the diamond-like carbon layer is selected from the group consisting of a:CH, i-CH, Me:CH, DLC and Me:DLC.

3. Apparatus according to claim 1 wherein the amorphous carbon layer has graphite structures with sp² hybridization in combination with diamond-like structures with sp³ hybridization.

4. Apparatus according to claim 1 wherein the amorphous carbon layer is present in a layer thickness of 1 to 10 μm.

5. Apparatus according to claim 1 wherein the pressure component is one of a pressure plate, a cylinder, a disc and a ring.

6. Apparatus according to claim 1 wherein the pressure component contains openings which serve to receive at least one of a temperature sensor and an electronic circuit.

7. Apparatus according to claim 1 wherein the amorphous carbon layer is provided with at least one of thin film electrodes, a thin film strip conductor, and bonding spots.

8. Apparatus according to claim 7 wherein the electrodes are structured for local measurement of the force distribution.

9. Apparatus according to claim 6 wherein the openings are provided for the contacting.

10. Apparatus according to claim 1 wherein the pressure component is a disc which is provided on both sides with the amorphous carbon layer.

11. Apparatus according to claim 1 wherein the pressure component comprises two discs and amorphous carbon layers applied on one side thereof and a metal sheet-like electrode which is disposed between the discs, the amorphous carbon layers facing each other.

12. Apparatus according to claim 6 wherein the openings are sealed.

13. (canceled)

14. Apparatus according to claim 2 wherein the amorphous carbon layer has graphite structures with sp² hybridization in combination with diamond-like structures with sp³ hybridization.

15. Apparatus according to claim 1 wherein the amorphous carbon layer is doped.

16. Apparatus according to claim 2 wherein the amorphous carbon layer is doped.

17. Apparatus according to claim 2 wherein the amorphous carbon layer is present in a layer thickness of 1 to 10 μm.

18. Apparatus according to claim 3 wherein the amorphous carbon layer is present in a layer thickness of 1 to 10 μm.

19. Apparatus according to claim 14 wherein the amorphous carbon layer is present in a layer thickness of 1 to 10 μm.

20. Apparatus according to claim 15 wherein the amorphous carbon layer is present in a layer thickness of 1 to 10 μm.

21. Apparatus according to claim 16 wherein the amorphous carbon layer is present in a layer thickness of 1 to 10 μm.

22. A method of making a vehicle brake system comprising at least one force sensor subassembly and at least one signal processing mechanism per brake, the at least one force sensor subassembly comprising a brake actuator which is in frictional connection to at least one pressure component, the method comprising providing the at least one pressure component at least partially with an amorphous piezoresistive diamond-like carbon layer which forms a force sensor.
